(19) United States
(12) Patent Application Publication
(10) Pub. No.: US 2011/0279702 A1
(43) Pub. Date: Nov. 17, 2011

(54) Method and System for Providing a Programmable and Flexible Image Sensor Pipeline for Multiple Input Patterns

(76) Inventors: David Plowman, Great Chesterford (GB); Adrian Lees, Cambridge (GB)

(21) Appl. No.: 12/986,400

(22) Filed: Jan. 7, 2011

Related U.S. Application Data
(60) Provisional application No. 61/345,421, filed on May 17, 2010.

(51) Int. Cl. H04N 9/73

(52) U.S. Cl. 348/223.1; 348/E09.051

(57) ABSTRACT

A method and system are provided in which color channel information may be stored in a multimedia processor. The color channel information may comprise information for each of the color filter positions in a color filter pattern. The color channel information may be stored in a plurality of registers, wherein each register may correspond to a color channel. The color channel information may be dynamically stored in the multimedia processor. Based on the color channel information, a color channel may be assigned to each color filter position. The color channel assigned to a color filter position may be one of red, green, blue, white, cyan, yellow, and/or magenta. When an indication of the color filter pattern is received, the assignment may be based on both the color channel information and the received indication. Pixel values associated with the color filter pattern may be processed based on the color channel assignment.

### CROSS-REFERENCE TO RELATED APPLICATIONS/INCORPORATION BY REFERENCE

This application makes reference to, claims priority to, and claims benefit of U.S. Provisional Application Ser. No. 61/345,421, filed May 17, 2010.

This application also makes reference to:
U.S. patent application Ser. No. 12/795,170 (Attorney Docket Number 21160US02) which was filed on Jun. 7, 2010;
U.S. patent application Ser. No. 12/686,800 (Attorney Docket Number 21161US02) which was filed on Jan. 13, 2010;
U.S. patent application Ser. No. 12/953,128 (Attorney Docket Number 21162US02) which was filed on Nov. 23, 2010;
U.S. patent application Ser. No. 12/868,192 (Attorney Docket Number 21163US02) which was filed on Aug. 25, 2010;
U.S. patent application Ser. No. 12/953,739 (Attorney Docket Number 21164US02) which was filed on Nov. 24, 2010;
U.S. patent application Ser. No. _________ (Attorney Docket Number 21165US02) which was filed on __________;
U.S. patent application Ser. No. 12/942,626 (Attorney Docket Number 21166US02) which was filed on Nov. 9, 2010;
U.S. patent application Ser. No. _________(Attorney Docket Number 21168US02) which was filed on ____________;
U.S. patent application Ser. No. 12/907,213 (Attorney Docket Number 21169US02) which was filed on Oct. 19, 2010;
U.S. patent application Ser. No. 12/953,756 (Attorney Docket Number 21172US02) which was filed on Nov. 24, 2010;
U.S. patent application Ser. No. 12/869,900 (Attorney Docket Number 21176US02) which was filed on Aug. 27, 2010; and
U.S. patent application Ser. No. 12/835,522 (Attorney Docket Number 21178US02) which was filed on Jul. 13, 2010.

Each of the above stated applications is hereby incorporated herein by reference in its entirety.

### FIELD OF THE INVENTION

Certain embodiments of the invention relate to image processing in communication systems. More specifically, certain embodiments of the invention relate to a method and system for providing a programmable and flexible image sensor pipeline for multiple input patterns.

### BACKGROUND OF THE INVENTION

Image and video capabilities may be incorporated into a wide range of devices such as, for example, cellular phones, personal digital assistants, digital televisions, digital direct broadcast systems, digital recording devices, gaming consoles and the like. Operating on video data, however, may be very computationally intensive because of the large amounts of data that need to be constantly moved around. This normally requires systems with powerful processors, hardware accelerators, and/or substantial memory, particularly when video encoding is required. Such systems may typically use large amounts of power, which may make them less than suitable for certain applications, such as mobile applications.

Due to the ever growing demand for image and video capabilities, there is a need for power-efficient, high-performance, multimedia processors that may be used in a wide range of applications, including mobile applications. Such multimedia processors may support multiple operations including audio processing, image sensor processing, video recording, media playback, graphics, three-dimensional (3D) gaming, and/or other similar operations.

Further limitations and disadvantages of conventional and traditional approaches will become apparent to one of skill in the art, through comparison of such systems with the present invention as set forth in the remainder of the present application with reference to the drawings.

### BRIEF SUMMARY OF THE INVENTION

A system and/or method for providing a programmable and flexible image sensor pipeline for multiple input patterns, as set forth more completely in the claims.

Various advantages, aspects and novel features of the present invention, as well as details of an illustrated embodiment thereof, will be more fully understood from the following description and drawings.

### BRIEF DESCRIPTION OF SEVERAL VIEWS OF THE DRAWINGS

FIG. 1A is a block diagram of an exemplary multimedia system, in accordance with an embodiment of the invention.

FIG. 1B is a block diagram of an exemplary multimedia processor that is operable to provide a programmable and flexible image sensor pipeline for multiple input patterns, in accordance with an embodiment of the invention.

FIG. 2A is a block diagram of an exemplary mobile device configured to provide a programmable and flexible image sensor pipeline for multiple input patterns, in accordance with an embodiment of the invention.

FIG. 2B is a block diagram of an exemplary image processing system comprising a portion of the image sensor pipeline of FIG. 2A, in accordance with an embodiment of the invention.

FIGS. 3A and 3B are diagrams that illustrate an exemplary image sensor with color filter array and pixel array, in connection with an embodiment of the invention.

FIG. 4 is a diagram that illustrates exemplary 2×2 color filter patterns that may be utilized for image processing operations, in connection with an embodiment of the invention.

FIG. 5 is a diagram that illustrates exemplary 4×4 color filter patterns that may be utilized for image processing operations, in connection with an embodiment of the invention.

FIGS. 6A and 6B are diagrams that illustrate multiple registers for assigning color channels to the various color filter positions in a plurality of color filter patterns, in accordance with an embodiment of the invention.

FIGS. 7A and 7B are diagrams that illustrate utilizing four registers to assign W, G, B, and R color channels to a color filter pattern with a 4×4 array of color filters, in accordance with an embodiment of the invention.

FIGS. 8A-8C are diagrams that illustrate utilizing either four registers or a single register to assign C, Y, M, and G color channels to a 2×2 color filter pattern, in accordance with an embodiment of the invention.

FIG. 9 is a flow diagram that illustrates the assignment of color channels to the various color filter positions in a color filter pattern, in accordance with an embodiment of the invention.

### DETAILED DESCRIPTION OF THE INVENTION

Certain embodiments of the invention can be found in a method and system for providing a programmable and flexible image sensor pipeline for multiple input patterns. Various embodiments of the invention provide an integrated circuit that comprises a multimedia processor in which color channel information may be stored. The color channel information may comprise information for each of the color filter positions in a color filter pattern. Based on the stored color channel information, a color channel from a plurality of color channels may be assigned to each of the color filter positions in the color filter pattern. Pixel values associated with the color filter pattern may be processed based on the color channel assignment. The color channel information may be dynamically stored or programmed into the multimedia processor. An indication of the color filter pattern may be received by the multimedia processor that may also be utilized for assigning color channels to the color filter positions in the color filter pattern.

The color filter pattern may be one of a plurality of color filter patterns supported by the multimedia processor in which the color filter pattern comprises an N×M array of color filters, and where N and M are positive integers such that N×M≧3. The plurality of color channels may comprise a red color channel, a blue color channel, a green color channel, a white color channel, a cyan color channel, a yellow color channel, a magenta color channel, and/or a green color channel.

In an embodiment of the invention, storing color channel information may comprise storing such information in a plurality of registers in the multimedia processor. Each of the registers may correspond to one of the color channels. For example, the plurality of registers may comprise a first register that corresponds to a red color channel, a second register that corresponds to a blue color channel, a third register that corresponds to a green color channel, and a fourth register that corresponds to a white or panchromatic color channel. In another example, the plurality of registers may comprise a first register that corresponds to a cyan color channel, a second register that corresponds to a yellow color channel, a third register that corresponds to a magenta color channel, and a fourth register that corresponds to a green color channel. One or more bits in each of the registers associated with a color channel may correspond to one of the color filter positions in the color filter pattern.

The above-described multimedia processor may be utilized in a plurality of applications, including those supported by mobile communication devices, for example.

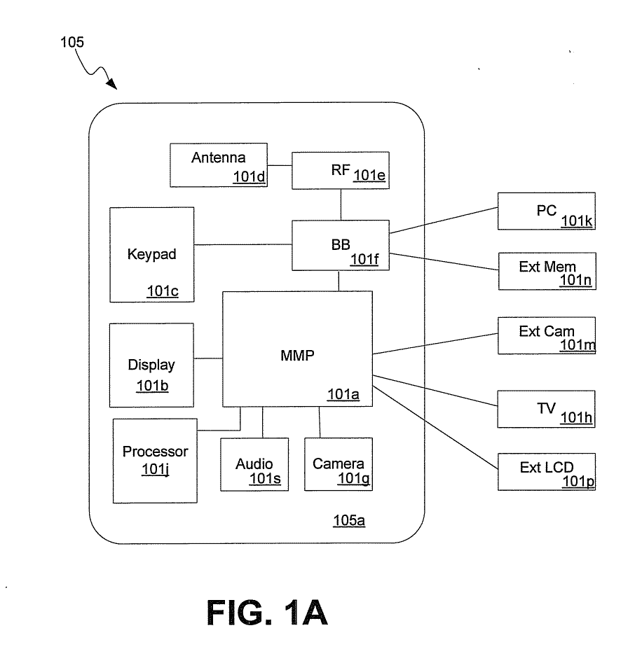

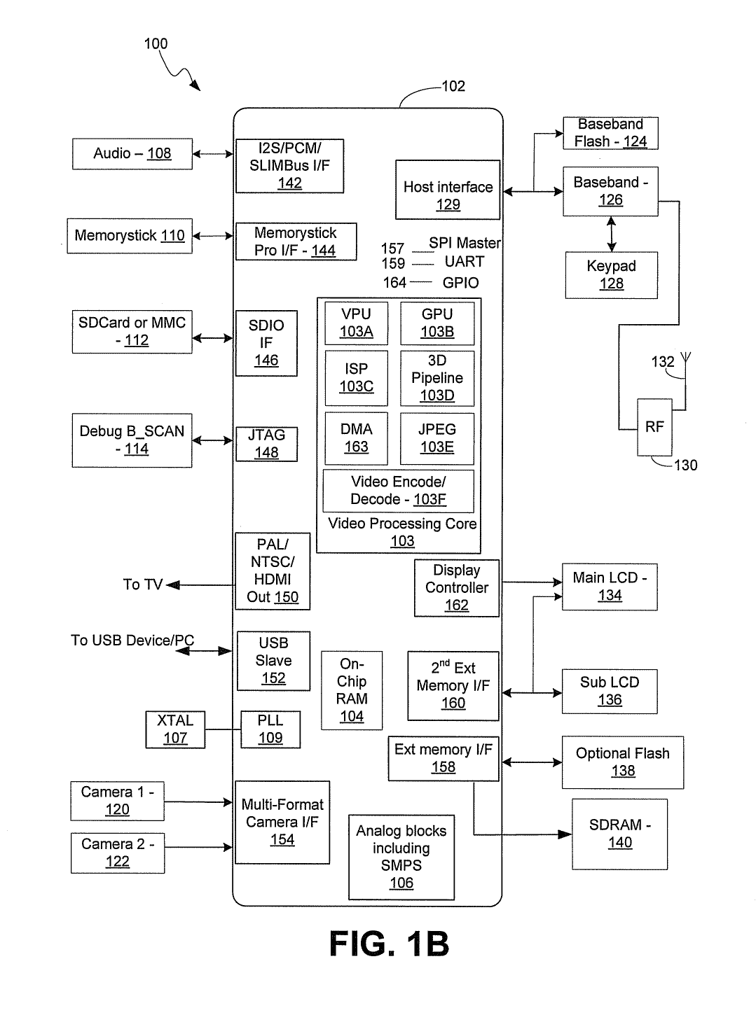

FIG. 1A is a block diagram of an exemplary multimedia system, in accordance with an embodiment of the invention. Referring to FIG. 1A, there is shown a mobile multimedia system 105 that comprises a mobile multimedia device 105a, a television (TV) 101h, a personal computer (PC) 101k, an external camera 101m, external memory 101n, and external liquid crystal display (LCD) 101p. The mobile multimedia device 105a may be a cellular telephone or other handheld communication device. The mobile multimedia device 105a may comprise a mobile multimedia processor (MMP) 101a, an antenna 101d, an audio block 101s, a radio frequency (RF) block 101e, a baseband processing block 101f, a display 101b, a keypad 101c, and a camera 101g. The display 101b may comprise an LCD and/or a light-emitting diode (LED).

The MMP 101a may comprise suitable circuitry, logic, interfaces, and/or code that may be operable to perform video and/or multimedia processing for the mobile multimedia device 105a. The MMP 101a may also comprise integrated interfaces, which may be utilized to support one or more external devices coupled to the mobile multimedia device 105a. For example, the MMP 101a may support connections to a TV 101h, an external camera 101m, and an external LCD 101p.

The MMP 101a may be operable to perform processing of image data from a plurality of different types of image sensors. The MMP 101a may comprise an image sensor pipeline that may be operable to process image data based on a type of color filter array (CFA) in the image sensor that is utilized to capture the image data. For example, a first image sensor may utilize a CFA having a first type of color filter pattern comprising a 2×2 array of red, green, and blue color filters. In a second example, a second image sensor may utilize a CFA having a second type of color filter pattern comprising a 2×2 array of cyan, yellow, and magenta color filters. In a third example, a third image sensor may utilize a CFA having a third type of color filter pattern comprising a 4×4 array of red, green, blue, and panchromatic color filters. The MMP 101a may be operable to program the image sensor pipeline to process image data from any one of the above-described exemplary image sensors by assigning appropriate color channels to each of the color filter positions in the color filter pattern. In this manner, color filter patterns having a wide range of array sizes and/or filter colors may be concurrently supported by the MMP 101a. Thus, rather than having a fixed architecture that may be able to support a limited number image sensors from which to receive image data, the MMP 101a may provide a programmable and flexible image sensor pipeline architecture for processing a wide range of input patterns.

The processor 101j may comprise suitable circuitry, logic, interfaces, and/or code that may be operable to control processes in the mobile multimedia system 105. Although not shown in FIG. 1A, the processor 101j may be coupled to a plurality of devices in and/or coupled to the mobile multimedia system 105.

In operation, the mobile multimedia device may receive signals via the antenna 101d. Received signals may be processed by the RF block 101e and the RF signals may be converted to baseband by the baseband processing block 101f. Baseband signals may then be processed by the MMP 101a. Audio and/or video data may be received from the external camera 101m, and image data may be received via the integrated camera 101g. During processing, the MMP 101a may utilize the external memory 101n for storing of processed data. Processed audio data may be communicated to the audio block 101s and processed video data may be communicated to the display 101b and/or the external LCD 101p, for example. The keypad 101c may be utilized for communicating processing commands and/or other data, which may be required for audio or video data processing by the MMP 101a.

In an embodiment of the invention, the MMP 101a may be operable to process image data generated by the image sensor in the camera 101m. The image sensor pipeline in the MMP 101a may perform the image data processing based on a color filter pattern associated with the CFA of the image sensor in the camera 101m. In an embodiment of the invention, the camera 101m may provide an indication of the color filter pattern to the MMP 101a and the MMP 101a may be operable to program the operation of the image sensor pipeline based on the received indication. In another embodiment of the invention, a default color filter pattern may be programmed into the image sensor pipeline for use with a wide range of image sensors.

FIG. 1B is a block diagram of an exemplary multimedia processor that is operable to provide a programmable and flexible image sensor pipeline for multiple input patterns, in accordance with an embodiment of the invention. Referring to FIG. 1B, the mobile multimedia processor 102 may comprise suitable logic, circuitry, interfaces, and/or code that may be operable to perform video and/or multimedia processing for handheld multimedia products. For example, the mobile multimedia processor 102 may be designed and optimized for video record/playback, mobile TV and 3D mobile gaming, utilizing integrated peripherals and a video processing core. The mobile multimedia processor 102 may comprise a video processing core 103 that may comprise a vector processing unit (VPU) 103A, a graphic processing unit (GPU) 103B, an image sensor pipeline (ISP) 103C, a 3D pipeline 103D, a direct memory access (DMA) controller 163, a Joint Photographic Experts Group (JPEG) encoding/decoding module 103E, and a video encoding/decoding module 103F. The mobile multimedia processor 102 may also comprise on-chip RAM 104, an analog block 106, a phase-locked loop (PLL) 109, an audio interface (I/F) 142, a memory stick I/F 144, a Secure Digital input/output (SDIO) I/F 146, a Joint Test Action Group (JTAG) I/F 148, a TV output I/F 150, a Universal Serial Bus (USB) I/F 152, a camera I/F 154, and a host I/F 129. The mobile multimedia processor 102 may further comprise a serial peripheral interface (SPI) 157, a universal asynchronous receiver/transmitter (UART) I/F 159, a general purpose input/output (GPIO) pins 164, a display controller 162, an external memory I/F 158, and a second external memory I/F 160.

Also shown in FIG. 1B are an audio block 108 that may be coupled to the audio interface I/F 142, a memory stick 110 that may be coupled to the memory stick I/F 144, an SD card block 112 that may be coupled to the SDIO IF 146, and a debug block 114 that may be coupled to the JTAG I/F 148. The PAL/NTSC/high definition multimedia interface (HDMI) TV output I/F 150 may be utilized for communication with a TV, and the USB 1.1, or other variant thereof, slave port I/F 152 may be utilized for communications with a PC, for example. A crystal oscillator (XTAL) 107 may be coupled to the PLL 109. Cameras 120 and/or 122 may be coupled to the camera I/F 154.

Moreover, FIG. 1B shows a baseband processing block 126 that may be coupled to the host interface 129, a radio frequency (RF) processing block 130 coupled to the baseband processing block 126 and an antenna 132, a basedband flash 124 that may be coupled to the host interface 129, and a keypad 128 coupled to the baseband processing block 126. A main LCD 134 may be coupled to the mobile multimedia processor 102 via the display controller 162 and/or via the second external memory interface 160, for example, and a subsidiary LCD 136 may also be coupled to the mobile multimedia processor 102 via the second external memory interface 160, for example. Moreover, an optional flash memory 138 and/or an SDRAM 140 may be coupled to the external memory I/F 158.

The video processing core 103 may comprise suitable logic, circuitry, interfaces, and/or code that may be operable to perform video processing of data. The on-chip Random Access Memory (RAM) 104 and the Synchronous Dynamic RAM (SDRAM) 140 comprise suitable logic, circuitry and/or code that may be adapted to store data such as image or video data.

The VPU 103A may comprise suitable logic, circuitry, code, and/or interfaces that may be operable to perform video processing of data. In an embodiment of the invention, the VPU 103A may comprise a plurality of scalar cores (not shown) and a single vector core (not shown) to perform image processing operations.

The image sensor pipeline (ISP) 103C may comprise suitable circuitry, logic and/or code that may be operable to process image data. The ISP 103C may perform a plurality of processing techniques comprising filtering, demosaic, lens shading correction, defective pixel correction, white balance, image compensation, interpolation, color transformation, and post filtering, for example. The processing of image data may be performed on variable sized tiles, reducing the memory requirements of the ISP 103C processes.

The ISP 103C may be operable to support image data processing for a wide range of color filter patterns. In this regard, the ISP 103C may comprise a dynamically programmable and flexible architecture for processing multiple input patterns. For example, the ISP 103C may support a plurality of color filter patterns by allowing each color filter position in a color filter pattern to be assigned a color channel from a plurality of color channels that are also supported by the ISP 103C. The color channel assignment is based on color channel information stored in a storage location, such as one or more registers, for example, in the mobile multimedia processor 102 and/or in the ISP 103C. By having a dynamically programmable and flexible architecture, the ISP 103C enables color filter patterns comprising filters of different colors and/or having different array sizes to be processed without the need to hard-wire the image data processing for each supported color filter patterns. Moreover, a dynamically programmable and flexible architecture may allow new color filter patterns to be supported by simply storing additional color channel information or updating the color channel information currently stored in the mobile multimedia processor 102.

The GPU 103B may comprise suitable logic, circuitry, interfaces, and/or code that may be operable to offload graphics rendering from a general processor, such as the processor 101j, described with respect to FIG. 1A. The GPU 103B may be operable to perform mathematical operations specific to graphics processing, such as texture mapping and rendering polygons, for example.

The 3D pipeline 103D may comprise suitable circuitry, logic and/or code that may enable the rendering of 2D and 3D graphics. The 3D pipeline 103D may perform a plurality of processing techniques comprising vertex processing, rasterizing, early-Z culling, interpolation, texture lookups, pixel shading, depth test, stencil operations and color blend, for example. The 3D pipeline 103D may be operable perform tile mode rendering in two separate phases, a first phase comprising a binning process or operation, and a second phase comprising a rendering process or operation

The JPEG module 103E may comprise suitable logic, circuitry, interfaces, and/or code that may be operable to encode and/or decode JPEG images. JPEG processing may enable compressed storage of images without significant reduction in quality.

The video encoding/decoding module 103F may comprise suitable logic, circuitry, interfaces, and/or code that may be operable to encode and/or decode images, such as generating full 108p HD video from H.264 compressed data, for example. In addition, the video encoding/decoding module 103F may be operable to generate standard definition (SD) output signals, such as phase alternating line (PAL) and/or national television system committee (NTSC) formats.

In operation, the mobile multimedia processor 102 may perform power-efficient multimedia processing operations. More particularly, the VPU 103A in the mobile multimedia processor 102 may perform power-efficient video and/or audio data processing operations. In this regard, the VPU 103A may be suspended after decoding encoded audio data and may be woken up when additional decoded audio data is needed. The VPU 103A may be powered down by regulating the power that is provided to the power domain in the video processing core 103 associated with the VPU 103A. State information related to the various devices, modules, and/or components in the video processing core 103, including the VPU 103A, may be stored or saved in, for example, the SDRAM 140. When additional decoded audio data is needed, one or more signals may be generated by the audio interface 142 that may be utilized to wake up the VPU 103A. In this regard, power may be reestablished to the power domain in the video processing core 103 that is associated with the VPU 103A and the stored state information may be retrieved to reboot the VPU 103A.

In an embodiment of the invention, the ISP 103C in the video processing core 103 of the mobile multimedia processor 102 may be operable to process data from the image sensor in, for example, the camera 120 or the camera 122. The ISP 103C may be operable to perform various processing operations on image data received from an external camera based on a color filter pattern associated with the CFA of the image sensor in that camera. In an embodiment of the invention, the external camera may provide an indication of the color filter pattern to the mobile multimedia processor 102 that may enable the mobile multimedia processor to program, configure, and/or enable the operation of the ISP 103C based on the received indication. In another embodiment of the invention, the ISP 103C may operate based on a default color filter pattern that may be utilized with a wide range of image sensors. Based on the color filter pattern and on the color channel information stored in the mobile multimedia processor 102, the ISP 103C may be operable to assign a color channel to each of the color filter positions in the color filter pattern and subsequently process the image data, such as pixel values, for example, in accordance with the color channel assignment.

In an embodiment of the invention, a new source of image data may be available that utilizes a color filter pattern that is different from the current color filter pattern that is being utilized by the ISP 103C. Such a case may occur when, for example, the image data is received from the camera 120 initially and is subsequently received from the camera 122. In such an instance, the ISP 103C may be programmed, configured, and/or enabled to operate based on the new color filter pattern by assigning the appropriate color channels to the color filter positions of the new color filter pattern. The assignment of color channels is based on the stored color channel information in the mobile multimedia processor 102. The stored color channel information may comprise information for each color filter position for a plurality of color filter patterns. Moreover, the stored color channel information may be dynamically modified and/or updated to allow the ISP 103C in the mobile multimedia processor 102 to process other color filter patterns that may not be currently supported.

The ISP 103C may be operable to process pixel values in a plurality of color channels. When a pixel value is processed with respect to a particular color channel, color channel information for that particular color channel, such as various processing parameters, matrix components, filter values, and/or the like, may be utilized to process the pixel values.

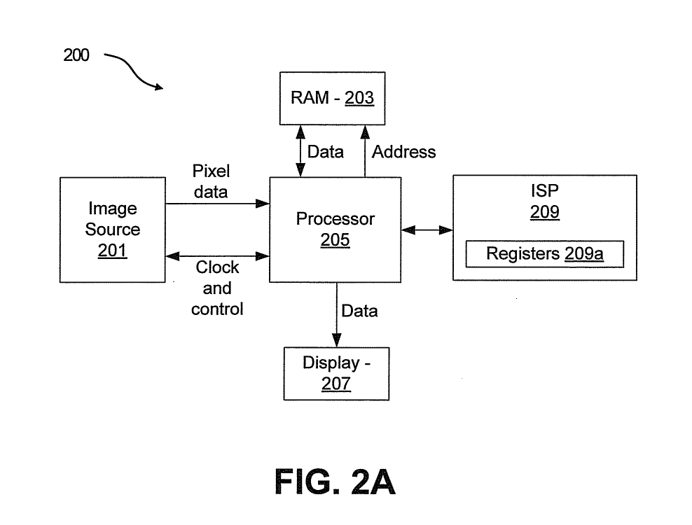

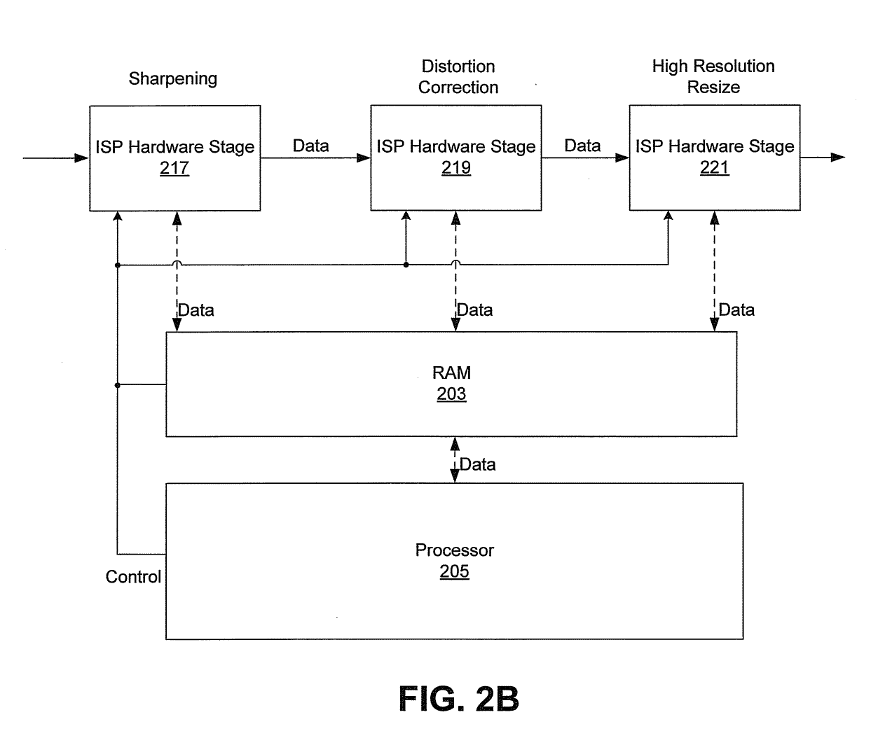

FIG. 2A is a block diagram of an exemplary mobile device configured to provide a programmable and flexible image sensor pipeline for multiple input patterns, in accordance with an embodiment of the invention. Referring to FIG. 2A, there is shown an image processing system 200 comprising an image source 201, a RAM 203, a processor 205, a display 207, and an ISP 209.

The image source 201 may comprise suitable circuitry, logic, code, and/or interfaces that may be operable capture a visual image by converting light to an electrical signal that represents the image. In this regard, the image source 201 may comprise, for example, a charged-coupled device (CCD) imager, a complimentary metal oxide semiconductor (CMOS) imager, or other like or suitable imaging device. The imager in the image source 210 may comprise a pixel array and a color filter array. The pixel array is an array of pixels that may be operable to capture the light and provide some level of front-end processing to the electrical signal generated from the captured light. The color filter array or CFA may comprise an array of color filters arranged in a pattern that is repeated throughout the CFA. The CFA provides spectral filtering of the light that is received by each pixel in the pixel array. The image source 201 may be communicatively coupled with the RAM 203 and the processing block 205.

The processor 205 may comprise suitable circuitry, logic, code, and/or interfaces that may be operable to send control signals and/or receive image data from the image source 201, the RAM 203 and/or the ISP 209. The image data may be processed in variable size tiles. The processor 205 may be operable to receive an indication from the image source 201 regarding the color filter pattern associated with the CFA of the imager in the image source 201. The processor 205 may send the indication to the ISP 209 and/or may utilize the indication to program, configure, and/or enable the ISP 209 to process the image data in accordance with the appropriate color filter pattern utilized in the image source 201. Moreover, the processor 205 may be enabled to manage one or more image processing steps. In this regard, the processor 205 may send control signals to the ISP 209. Moreover, the processor 205 may insert software image processing steps before or after one or more ISP hardware processing stages within the ISP 209. The processor 205 may also be enabled to communicate image data to the display 207.

The display 207 may comprise suitable circuitry, logic and/or code for displaying an image received from the image source 201 and the processing block 205.

The RAM 203 may comprise suitable circuitry, logic and/or code for storing data. The RAM 203 may be similar or substantially the same as the RAM 104 described in FIG. 1. The RAM 203 may be utilized to store image data as well as configuration data related to image processing. For example, characteristics of the image source 201 may be measured at the time of manufacture, and the distortion of the optics across a resulting image may be stored in the RAM 203. In another example, information related to the color filter pattern associated with the CFA of the imager in the image source 201 may be stored in the RAM 203. In such an instance, the processor 205 may read the color filter pattern information from the RAM 203 and may send that information to the ISP 209 and/or may utilize the color filter pattern information to program, configure and/or enable the ISP 209 to process the image data in accordance with the appropriate color filter pattern utilized in the image source 201.

The RAM 203 may also comprise color channel information for a plurality of different color channels such as red, blue, green, white, cyan, yellow, and/or magenta color channels, for example. The color channel information may comprise information for assigning a color channel to each color filter position in a color filter pattern. Moreover, the color channel information may comprise information for processing pixel values in accordance with a corresponding color channel. The ISP 209 may receive the color channel information stored in the RAM 203 to process pixel values.

The ISP 209 may comprise suitable circuitry, logic and/or code that may enable processing of image data received from the image source 201. Moreover, the ISP 209 may comprise suitable circuitry, logic and/or code allocated for a plurality of image processing tasks such as dark pixel compensation, lens shading correction, white balance and gain control, defective pixel correction, resampling, crosstalk correction, color filter pattern denoising, demosaicing, gamma correction, YCbCr denoising, false color suppression, sharpening, distortion correction, high resolution resize, color processing, color conversion, low resolution resize and output formatting for example. Various image processing steps may be performed by hardware in the ISP 209, and/or by software stored in the RAM 203 and executed by the processor 205. In this regard, image processing performed via software processes may be inserted before or after one or more of the ISP hardware image processing stages. The ISP 209 may be similar or substantially the same as the ISP 103C described above with respect to FIG. 1B.

The ISP 209 may comprise a programmable and flexible architecture that may be programmed, configured and/or enabled to process image data in accordance with a color filter pattern from a plurality of color filter patterns supported by the ISP 209. The ISP 209 may also be operable to support processing of pixel values in a plurality of color channels. In this regard, the ISP 209 may be operable to support red, green, blue, white, cyan, yellow, and/or magenta color channels. A white color channel may also be referred to as transparent or panchromatic color channel, for example, in instances when a particular color filter pattern is associated with the image data to be processed by the ISP 209, the ISP 209 may determine the color channel to which each of the color filter positions in the color filter pattern is assigned such that all pixel values associated with a particular color filter position are processed in accordance with the corresponding color channel. The determination of which color channel to assign to each color filter position may be based on, for example, the color channel information stored in one or more of the registers 209a in the ISP 209. By supporting a wide range of color filter channels, the ISP 209 may also be operable to support a plurality of input patterns. Moreover, because pixel value processing in the ISP 209 need not be hard-wired to any one color filter pattern, the ISP 209 may not only be operable to support a large number of color filter patterns, but may also support dynamically changing between image sources having CFAs with different color filter patterns and/or updating color channel information such that new or additional color filter patterns are supported.

In operation, the processor 205 may receive image data in tiled format from the image source 201. The processor 205 may provide clock and control signals for synchronizing transfer of image data from the image source 201. Image processing may begin when a tile is received. The image data may be passed to the ISP for various processing steps that may comprise dark pixel compensation, lens shading correction, white balance and gain control, defective pixel correction, resampling, crosstalk correction, color filter pattern denoising, demosaicing, gamma correction, YCbCr denoising, flase color suppression, sharpening, distortion correction, high resolution resize, color processing, color conversion, low resolution resize and output formatting for example. In some embodiments of the invention, the output of one or more ISP hardware image processing steps may be stored in the RAM 203. The processor 205 may fetch the image data from the RAM 203 and may perform one or more image processing steps via software.

FIG. 2B is a block diagram of an exemplary image processing system comprising a portion of the ISP 209 of FIG. 2A, in accordance with an embodiment of the invention. Referring to FIG. 2B, there is shown three ISP hardware processing stages 217, 219, and 221 of the ISP 209, the RAM 203, and the processor 205.

The ISP hardware processing stages 217, 219 and 221 may each perform an image processing task such as the tasks described above with respect to the ISP 209. The ISP stages 217, 219 and 221 may be communicatively coupled with a previous hardware stage and a subsequent hardware stage as well as the RAM 203 and the processor 205.

In operation, image data may be processed via a plurality of steps or stages such as the ISP 209 hardware processing stages 217, 219 and/or 221. Moreover, image data may be processed in steps or stages by software stored in the RAM 203 and executed by the processor 205. Accordingly, image data may be organized into a tile format wherein data for an image may be divided into variable size portions or tiles and processed on a per tile basis. Once an image data tile has entered the ISP 209 pipeline, an ISP 209 hardware processing stage may retrieve data from a previous ISP 209 hardware stage, may process the retrieved image data and may output the processed image data. In this regard, different stages of the ISP 209 may process different tiles of image data concurrently. Moreover, one or more software image processing stages may be inserted between ISP hardware processing stages. In this regard, the ISP stages 217, 219, and 221 may be configured to receive control signals from the processor 205 and to send and receive image data to and from the RAM 203. The processor 205 may be enabled to perform any of the image processing steps via software. Accordingly, processing of image data received from, for example, the image source 201, may be performed within hardware on the ISP 209 and/or by software programmed on the processor 205.

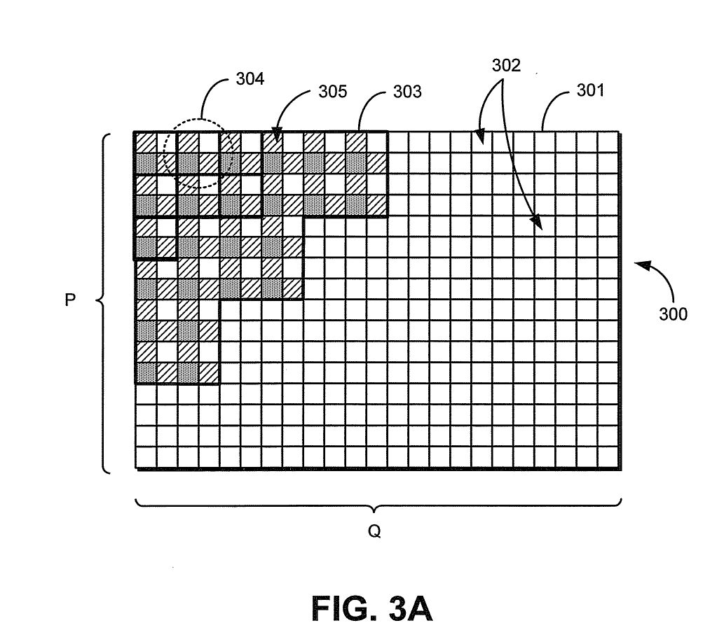

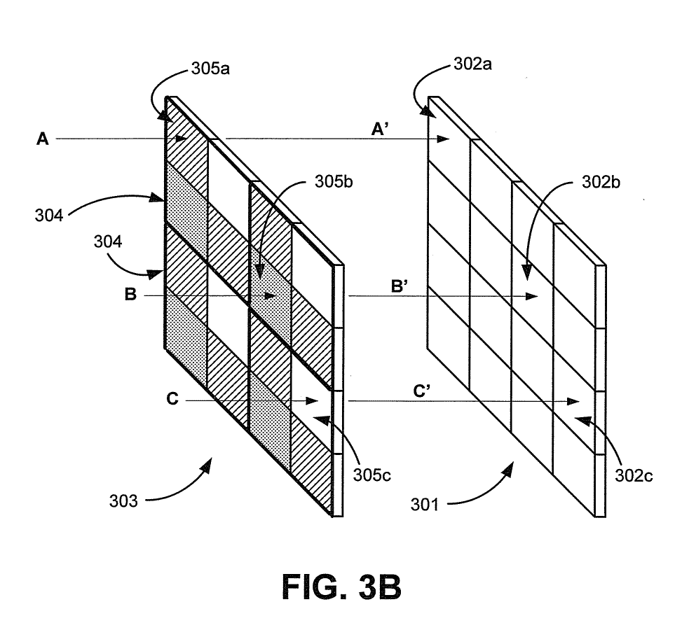

FIGS. 3A and 3B are diagrams that illustrate an exemplary image sensor with color filter array and pixel array, in connection with an embodiment of the invention. Referring to FIG. 3A, there is shown an image sensor 300 that may comprise a pixel array 301 and a color filter array or CFA 303. The pixel array 301 may comprise a plurality of pixels 302 arranged or organized in a P×Q array, where P is the number of rows and Q is the number of columns. In some instances, the total number of pixels 302 in the pixel array 301 may be multiples of millions of pixels.

The color filter array 303 may comprise a plurality of color filters 305 arranged or organized in an array placed over the pixel array 301. Only a portion of the color filter array 303 is shown in FIG. 3A to illustrate the placement of color filters 305 over the pixels 302. The color filters 305 in the color filter array 303 may be arranged or organized in a color filter pattern 304 that is repeated throughout the color filter array 303. The color filter pattern 304 may comprise a plurality of color filters 305 with different spectral characteristics, that is, different spectral filtering bandwidth. In one example, the color filter pattern 304 may comprise a 2×2 array of color filters in which one or more filters may have red light spectral characteristics, referred to as red color filters, one or more color filters may have blue light spectral characteristics, referred to as blue color filters, and one or more color filters may have green light spectral characteristics, referred to as green color filters.

Referring to FIG. 3B, there is shown a portion of the pixel array 301 and a corresponding portion of the color filter array 303. For purposes of illustration, the pixel array 301 and the color filter array 303 are shown separated from each other. In this exemplary embodiment of the invention, the color filter pattern 304 comprises a 2×2 array of color filters in which a top-left and bottom-right color filters, labeled 304a and shown in a diagonal lines pattern, have the same spectral characteristics. The 2×2 array in the color filter pattern 304 also comprises a top-right color filter, labeled 304c and shown in white, and a bottom-left color filter, labeled 304b and shown in a dotted pattern. The latter two color filters have color spectral characteristics that are different from each other and different from those of color filters 304a.

When an image is captured by the image sensor 300, a portion A of the light from that image is received at the location of the color filter 304a and a filtered portion A′ is transferred to a corresponding pixel 302a in the pixel array 301. A similar process occurs with portions B and C of the light from the image, which are filtered by color filters 304b and 304c, respectively, to produce filtered lights B′ and C′ that are received by their corresponding pixels 302b ad 302c in the pixel array 301. The electrical signal or electrical output of a pixel 302 in the pixel array 301 is based on the spectral characteristics, that is, the color, of the color filter in the color filter pattern 304 that corresponds to that pixel 302. Accordingly, when the pixel values associated with a pixel 302 are processed by, for example, the ISP 209 in FIG. 2A, the color of the corresponding color filter in the color filter pattern 304 is accounted for by processing that pixel 302 utilizing the appropriate color channel processing.

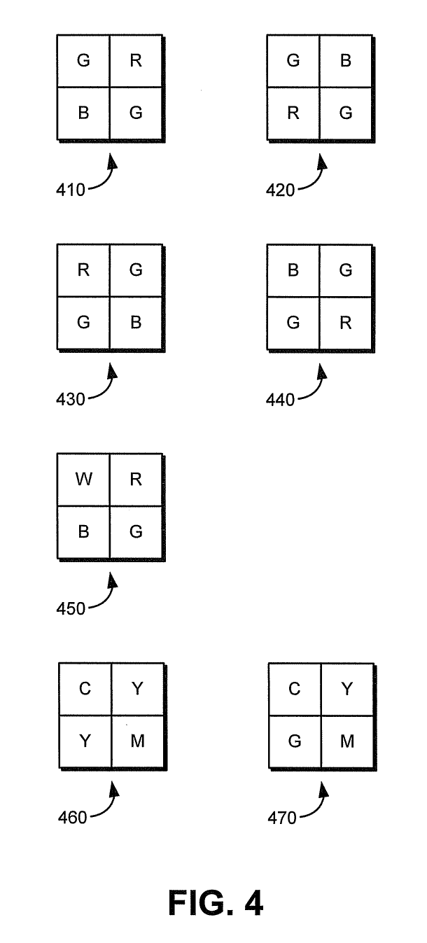

FIG. 4 is a diagram that illustrates exemplary 2×2 color filter patterns that may be utilized for image processing operations, in connection with an embodiment of the invention. Referring to FIG. 4, there is shown various examples of 2×2 arrays of color filters that may be utilized with, for example, the ISP 209. The color filter patterns 410, 420, 430, and 440, which are generally referred to as Bayer patterns, each comprises one red (R) color filter, one blue (B) color filter, and two green (G) color filters. The position of the filters, however, varies across the various color filter patterns 410, 420, 430, and 440.

The color filter pattern 450 comprises a red color filter, a blue color filter, a green color filter, and a white (W) color filter, also referred to as a panchromatic or transparent color filter. The panchromatic color filter may typically have a broader spectral bandwidth than that of the other color filters in the color filter pattern 450.

The color filter patterns 460 and 470 each comprises one cyan (C) color filter, one magenta (M) color filter, and two yellow (Y) color filters. The position of the color filters, however, varies across the various color filter patterns 460 and 470. In some instances, color filter patterns comprising cyan, yellow, and magenta color filters may be preferable because their spectral characteristics may be more suitable for certain applications.

The ISP 209, for example, may be operable to support the color filter patterns described above by assigning an appropriate color channel when processing pixel values associated with each of the positions in the color filter patterns. For example, by assigning G, R, B, and G color channel processing to the top-left, top-right, bottom-left, and bottom-right positions of a 2×2 array of color filters, respectively, the ISP 209 may be operable to process image data captured by an image sensor that utilizes the color filter pattern 410. In another example, by assigning C, Y, Y, and M color channel processing to the top-left, top-right, bottom-left, and bottom-right positions of a 2×2 array of color filters, respectively, the ISP 209 may be operable to process image data captured by an image sensor that utilizes the color filter pattern 460. In other words, by having a programmable and flexible architecture, the ISP 209 may be able to support image data processing for a wide range of 2×2 arrays of color filters.

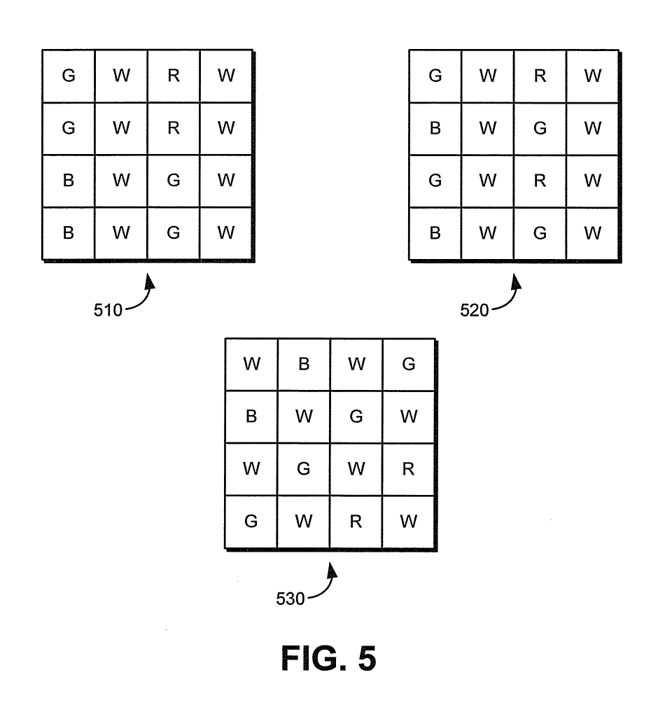

FIG. 5 is a diagram that illustrates exemplary 4×4 color filter patterns that may be utilized for image processing operations, in connection with an embodiment of the invention. Referring to FIG. 5, there is shown various examples of 4×4 arrays of color filters that may be utilized with, for example, the ISP 209. The color filter patterns 510, 520, and 530 each comprise a plurality of R color filters, B color filters, G color filters, and W color filters. The position of the color filters, however, varies across the various color filter patterns 510, 520, and 530.

The ISP 209, for example, may be operable to support the color filter patterns described in FIG. 5 by assigning an appropriate color channel when processing pixel values associated with each of the positions in the color filter patterns. For example, by assigning G, W, R, and W color channel processing to the two top rows and B, W, G, and W color channel processing to the two bottom rows of a 4×4 array of color filters, the ISP 209 may be operable to process image data captured by an image sensor that utilizes the color filter pattern 510. In another example, by assigning G, W, R, and W color channel processing to the top and third rows, and B, W, G, and W color channel processing to the second and bottom rows of a 4×4 array of color filters, the ISP 209 may be operable to process image data captured by an image sensor that utilizes the color filter pattern 520. In other words, by having a programmable and flexible architecture, the ISP 209 may be able to support image data processing for a wide range of 4×4 arrays of color filters. Moreover, the ISP 209 may be operable to support 2×2 arrays of color filters, such as those described in FIG. 4, for example, while also providing support for 4×4 arrays of color filters, such as those described in FIG. 5, for example.

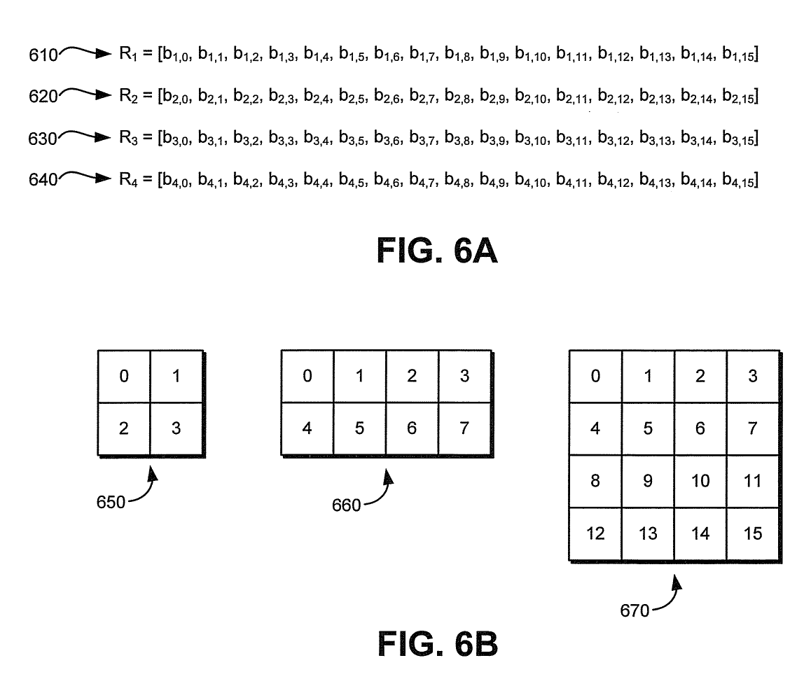

FIGS. 6A and 6B are diagrams that illustrate multiple registers for assigning color channels to the various color filter positions in a plurality of color filter patterns, in accordance with an embodiment of the invention. Referring to FIG. 6A, there is shown a first register 610 (R₁), a second register 620 (R₂), a third register 630 (R₃), and a fourth register 640 (R₄) associated with the operation of the ISP 209, for example. In an embodiment of the invention, the registers 610, 620, 630, and 640 may be comprised in the registers 209a described above with respect to FIG. 2A. In another embodiment of the invention, at least a portion of the registers 610, 620, 630, and 640 may be comprised in the processor 205, for example. In yet another embodiment, the registers 610, 620, 630, and 640 may be comprised in storage locations in, for example, the mobile multimedia processor 102.

In the exemplary embodiment of the invention described in FIG. 6A, each of the registers 610, 620, 630, and 640 may comprise 16 bits of data, where each bit of data may correspond to a color filter position in a color filter pattern having up to 16 color filter positions. Moreover, each of the registers 610, 620, 630, and 640 may be assigned to or be associated with a color channel processing in the ISP 209, for example. In this manner, a first color channel may be associated with the register 610, a second color channel may be associated with the register 620, a third color channel may be associated with the register 630, and a fourth color channel may be associated with the register 640

Referring to FIG. 6B, there are shown three different arrays of color filters, a 2×2 array 650, a 2×4 array 660, and a 4×4 array 670. The 2×2 array 650 comprises four color filters and corresponding color filter positions, the 2×4 array 660 comprises eight color filters and corresponding color filter positions, and the 4×4 array 670 comprises 16 color filters and corresponding color filter positions. In an embodiment of the invention, the ISP 209 may be operable to concurrently support one or more color filter patterns that utilize 2×2, 2×4, and 4×4 arrays.

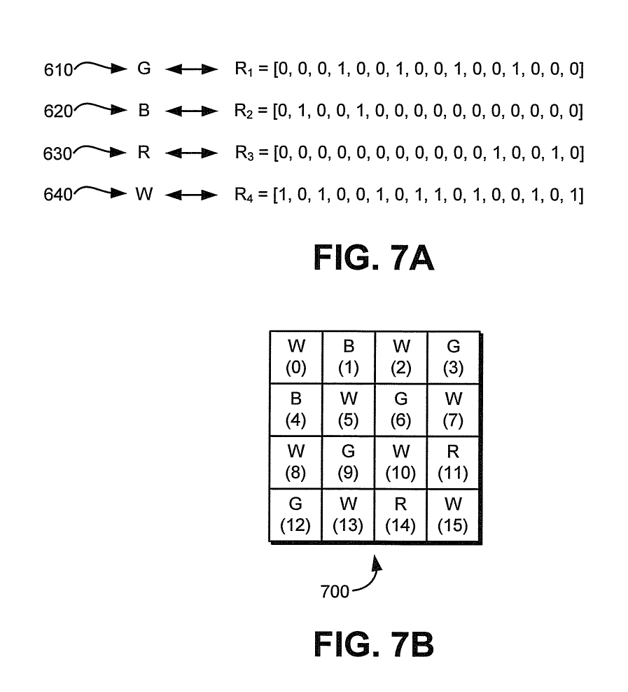

FIGS. 7A and 7B are diagrams that illustrate utilizing four registers to assign W, G, B, and R color channels to a color filter pattern with a 4×4 array of color filters, in accordance with an embodiment of the invention. Referring to FIG. 7A, there are shown the registers 610, 620, 630, and 640 of FIG. 6A, which are now associated with G, B, R, and W color channels, respectively. The association of the registers 610, 620, 630, and 640 to the G, B, R, and W color channels may be dynamically programmable.

The information stored in the registers 610, 620, 630, and 640 may be utilized to assign an appropriate color channel to each of the positions in the 4×4 array 700 shown in FIG. 7B. In an exemplary embodiment of the invention, the register 610, which is associated with the G color channel, has a logic one set in bit locations b_{1,3}, b_{1,6}, b_{1,9}, and b_{1,12}. Accordingly, the color filter positions 3, 6, 9, and 12 in the 4×4 array 700 are assigned to the G color channel. In another exemplary embodiment of the invention, the register 620, which is associated with the B color channel, has a logic one set in bit locations b_{2,1} and b_{2,4} such that the color filter positions 1 and 4 in the 4×4 array 700 are assigned to the B color channel. In another exemplary embodiment of the invention, the register 630, which is associated with the R color channel, has a logic one set in bit locations b_{3,11} and b_{3,14} such that the color filter positions 11 and 14 in the 4×4 array 700 are assigned to the R color channel. In yet another example, the register 640, which is associated with the W color channel, has a logic one set in bit locations b_{4,0}, b_{4,2}, b_{4,5}, b_{4,7}, b_{4,8}, b_{4,10}, b_{4,13}, and b_{4,15} such that the color filter positions 0, 2 ,5 ,7, 8, 10, 13,and 15 in the 4×4 array 700 are assigned to the W color channel. In this exemplary embodiment of the invention, the ISP 209, for example, may be programmed, configured, and/or enabled to support color channel processing of pixel values for image data associated with the color filter pattern 530 described above with respect to FIG. 5.

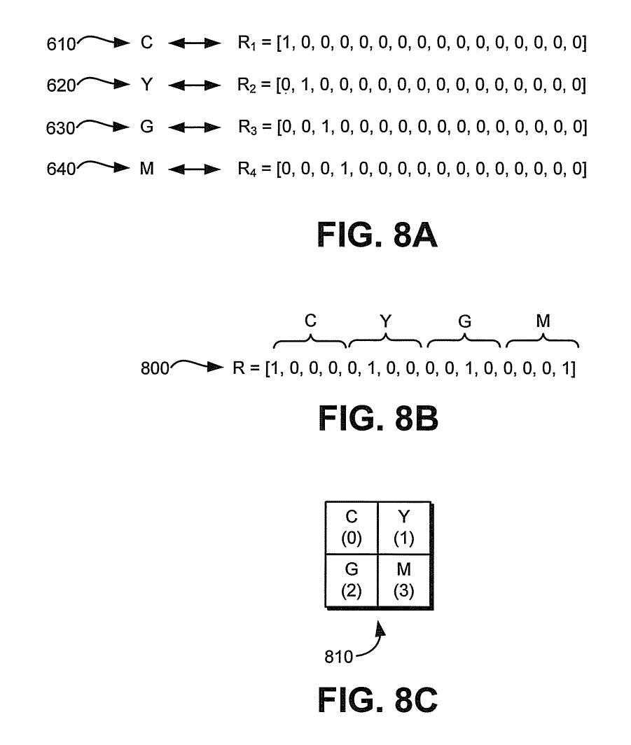

FIGS. 8A-8C are diagrams that illustrate utilizing either four registers or a single register to assign C, Y, M, and G color channels to a 2×2 color filter pattern, in accordance with an embodiment of the invention. Referring to FIG. 8A, there are shown the registers 610, 620, 630, and 640 of FIG. 6A, which are now associated with C, Y, G, and M color channels, respectively. The association of the registers 610, 620, 630, and 640 to the C, Y, G, and M color channels may be dynamically programmable.

The information stored in the registers 610, 620, 630, and 640 may be utilized to assign an appropriate color channel to each of the positions in the 2×2 array 810 shown in FIG. 7C. In an exemplary embodiment of the invention, the register 610, which is associated with the C color channel, has a logic one set in bit locations b_{1,0}. Accordingly, the color filter position 0 in the 2×2 array 810 is assigned to the C color channel. In another exemplary embodiment of the invention, the register 620, which is associated with the Y color channel, has a logic one set in bit location b_{2,1} such that the color filter position 1 in the 2×2 array 810 is assigned to the B color channel. In another exemplary embodiment of the invention, the register 630, which is associated with the G color channel, has a logic one set in bit location b_{3,2} such that the color filter position 2 in the 2×2 array 810 is assigned the G color channel. In another exemplary embodiment of the invention, the register 640, which is associated with the M color channel, has a logic one set in bit location b_{4,3} such that the color filter position 3 in the 2×2 array 810 is assigned the M color channel. In this exemplary embodiment of the invention, the ISP 209, for example, may be configured or enabled to support color channel processing of pixel values for image data associated with the color filter pattern 470 described above with respect to FIG. 4.

FIG. 8B illustrates using a single register to assign color channel information to each of the color filter positions in the 2×2 array 810. Since there are only four color filter positions in the 2×2 array 810, a single 16-bit register 800 may be utilized by associating portions of the register 800 with each of the color channels to be assigned. In this exemplary embodiment of the invention, a first set of four bit locations in the register 800 may be associated with the C color channel, a second set of four bit locations in the register 800 may be associated with the Y color channel, a third set of four bit locations in the register 800 may associated with the G color channel, and a fourth set of four bit locations in the register 800 may be associated with the M color channel.

In other embodiments of the invention, fewer or more registers than those illustrated in FIGS. 6A, 7A, 8A, and 8B may be utilized to address the number of color channels that need to be supported in an image sensor pipeline in connection with a color filter pattern and/or to address the number of color filter positions that need to be supported in connection with that color filter pattern. In an exemplary embodiment of the invention, for a color filter pattern that comprises 16 color filter positions and utilizes filters of four different colors, a single 64-bit register or storage location may be utilized in which four 16-bit portions of the 64-bit register may each be associated with a color filter channel.

While several color filter patterns are described herein, the disclosure need not be limited to those color filter patterns. Other color filter patterns may also be utilized in which color filters that may be different from those described above are included in the color filter pattern. For example, one may apply the same or similar methods and/or systems described herein to color filter patterns that include red, green, blue, and emerald color filters.

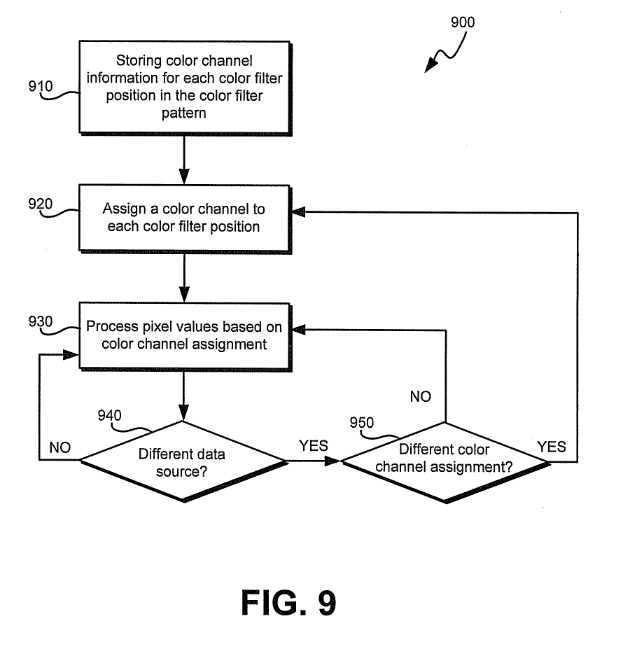

FIG. 9 is a flow diagram that illustrates the assignment of color channels to the various color filter positions in a color filter pattern, in accordance with an embodiment of the invention. Referring to FIG. 9, there is shown a flow chart 900 in which, at step 910, color channel information may be stored for each color filter position in a color filter pattern. At step 920, using the stored color channel information, a color channel may be assigned to each of the color filter positions in the color filter pattern. At step 930, pixel values associated with the color filter pattern may be processed in accordance with the color channel assignment.

At step 940, it may be determine whether a different source of image data is now being used to provide the pixel values for processing. When the source of image data and the color filter pattern remains the same, the process may continue. When a different source of image data exists, the process may proceed to step 950 in which it may be determined whether a different color channel assignment is needed as the new source of image data may utilize a different color filter array and color filter pattern. When a different color channel assignment is not needed, the process may proceed back to step 930 and the pixel values from the new source of image data may be processed utilized the current color channel assignment. When a different color channel assignment is needed, the process may proceed to step 920 in which color channel are assigned to each of the color filter positions in the color filter pattern of the new source of image data.

In an embodiment of the invention, color channel information may be stored in a multimedia processor, such as the multimedia processor 102 described above with respect to FIG. 1B. The multimedia processor may be in an integrated circuit, for example. The color channel information may comprise information for each color filter position from a plurality of color filter positions in a color filter pattern, such as the color filter patterns shown in FIGS. 4 and 5, for example. A color channel from a plurality of color channels may be to each color filter position from the plurality of color filter positions in the color filter pattern based on the stored color channel information. Pixel values associated with the color filter pattern may be processed based on the color channel assignment by, for example, the ISP 209 described above with respect to FIGS. 2A and 2B.

In an embodiment of the invention, the plurality of color channels may comprise a red color channel, a blue color channel, a green color channel, and a panchromatic color channel. In another embodiment of the invention, the plurality of color channels may comprise a cyan color channel, a yellow color channel, a magenta color channel, and a green color channel.

The color filter pattern may be one of a plurality of color filter patterns supported by the multimedia processor. Each color filter pattern from the plurality of color filter patterns may comprise an N×M array of color filters, where N and M are positive integers such that N×M≧3.

The storing of color channel information may comprise storing the color channel information in a plurality of registers in the multimedia processor, such as the registers 209a, for example. Each of the plurality of registers corresponds to a color channel from the plurality of color channels. In one embodiment of the invention, the plurality of registers may comprise a first register corresponding to a red color channel, a second register corresponding to a blue color channel, a third register corresponding to a green channel, and a fourth register corresponding to a panchromatic channel, as illustrated by the registers 610, 620, 630, and 640 in FIG. 7A. In another embodiment of the invention, the plurality of registers may comprise a first register corresponding to a cyan color channel, a second register corresponding to a yellow color channel, a third register corresponding to a magenta channel, and a fourth register corresponding to a green channel, as illustrated by the registers 610, 620, 630, and 640 in FIG. 8A. One or more bits in the plurality of registers may correspond to a color filter position the said plurality of color filter positions in the color filter pattern.

In an embodiment of the invention, the stored color channel information may be dynamically stored in the multimedia processor. Such dynamic storage may be utilized to update color channel information and/or to provide color channel information for additional color filter patterns that may be supported by the multimedia processor.

In another embodiment of the invention, an indication may be received by, for example, the mobile multimedia processor 102, regarding the color filter pattern. The indication may be received from one of cameras 120 and 122, for example. The assignment of a color channel from a plurality of color channels supported to each color filter position from the plurality of color filter positions in the color filter pattern may be based on the stored color channel information and the received indication. In this regard, a received indication may be utilized to program, reconfigure, operate, and/or enable the ISP 103C or the ISP 209 to process data from the image source in accordance with the color filter pattern of that image source.

Another embodiment of the invention may provide a non-transitory machine and/or computer readable storage and/or medium, having stored thereon, a machine code and/or a computer program having at least one code section executable by a machine and/or a computer, thereby causing the machine and/or computer to perform the steps as described herein for providing a programmable and flexible image sensor pipeline for multiple input patterns.

Accordingly, the present invention may be realized in hardware, software, or a combination of hardware and software. The present invention may be realized in a centralized fashion in at least one computer system or in a distributed fashion where different elements may be spread across several interconnected computer systems. Any kind of computer system or other apparatus adapted for carrying out the methods described herein is suited. A typical combination of hardware and software may be a general-purpose computer system with a computer program that, when being loaded and executed, controls the computer system such that it carries out the methods described herein.

The present invention may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will include all embodiments falling within the scope of the appended claims.

What is claimed is:

1. A method for image processing, comprising:
in an integrated circuit comprising a multimedia processor:
storing color channel information that comprises information for each color filter position from a plurality of color filter positions in a color filter pattern;
assigning, based on said stored color channel information, a color channel from a plurality of color channels to each color filter position from said plurality of color filter positions in said color filter pattern; and
processing pixel values associated with said color filter pattern based on said color channel assignment.

2. The method according to claim 1, wherein said plurality of color channels may comprise a red color channel, a blue color channel, a green color channel, and a white color channel.

3. The method according to claim 1, wherein said plurality of color channels may comprise a cyan color channel, a yellow color channel, a magenta color channel, and a green color channel.

4. The method according to claim 1, wherein:
said color filter pattern is one of a plurality of color filter patterns supported by said multimedia processor; and
each color filter pattern from said plurality of color filter patterns comprises an N×M array of color filters, N and M both being positive integers such that N×M≧3.

5. The method according to claim 1, wherein said storing comprises storing said color channel information in a plurality of registers in said multimedia processor, each of said plurality of registers corresponding to a color channel from said plurality of color channels.

6. The method according to claim 5, wherein said plurality of registers comprises:
a first register corresponding to a red color channel;
a second register corresponding to a blue color channel;
a third register corresponding to a green color channel;
a fourth register corresponding to a white color channel.

7. The method according to claim 5, wherein said plurality of registers comprises:
a first register corresponding to a cyan color channel;
a second register corresponding to a yellow color channel;
a third register corresponding to a magenta color channel;
a fourth register corresponding to a green color channel.

8. The method according to claim 5, wherein one or more bits in said plurality of registers correspond to a color filter position from said plurality of color filter positions in said color filter pattern.

9. The method according to claim 1, comprising dynamically storing said stored color channel information in said multimedia processor.

10. The method according to claim 1, comprising:
receiving an indication of said color filter pattern; and
assigning, based on said stored color channel information and said received indication, a color channel from said plurality of color channels to each color filter position from said plurality of color filter positions in said color filter pattern.

11. A system for image processing, comprising:
an integrated circuit comprising a multimedia processor, said multimedia processor being operable to:
store color channel information, said color channel information comprising information for each color filter position from a plurality of color filter positions in a color filter pattern;
assign, based on said stored color channel information, a color channel from a plurality of color channels to each color filter position from said plurality of color filter positions in said color filter pattern; and
process pixel values associated with said color filter pattern based on said color channel assignment.

12. The system according to claim 11, wherein said plurality of color channels comprise a red color channel, a blue color channel, a green color channel, and a white color channel.

13. The system according to claim 11, wherein said plurality of color channels comprise a cyan color channel, a yellow color channel, a magenta color channel, and a green color channel.

14. The system according to claim 11, wherein:
said color filter pattern is one of a plurality of color filter patterns supported by said multimedia processor; and
each color filter pattern from said plurality of color filter patterns comprises an N×M array of color filters, N and M both being positive integers such that N×M≧3.

15. The system according to claim 11, wherein said multimedia processor comprises a plurality of registers, said multimedia processor being operable to store said color channel information in said plurality of registers, each of said plurality of registers corresponding to a color channel from said plurality of color channels.

16. The system according to claim 15, wherein said plurality of registers comprises:
a first register corresponding to a red color channel;
a second register corresponding to a blue color channel;
a third register corresponding to a green color channel;
a fourth register corresponding to a white color channel.

17. The system according to claim 15, wherein said plurality of registers comprises:
a first register corresponding to a cyan color channel;
a second register corresponding to a yellow color channel;
a third register corresponding to a magenta color channel;
a fourth register corresponding to a green color channel.

18. The system according to claim 15, wherein one or more bits in said plurality of registers correspond to a color filter position from said plurality of color filter positions in said color filter pattern.

19. The system according to claim 11, wherein said multimedia processor is operable to dynamically store said stored color channel information in said multimedia processor.

20. The system according to claim 11, wherein said multimedia processor is operable to:
receive an indication of said color filter pattern; and
assign, based on said stored color channel information and said received indication, a color channel from a plurality of color channels to each color filter position from said plurality of color filter positions in said color filter pattern.
